(19) United States
(12) Patent Application Publication
(10) Pub. No.: US 2001/0033373 A1
(43) Pub. Date: Oct. 25, 2001

(54) Furnace-type atomic absorption spectrophotometer

(76) Inventor: Masumi Sakai, Ukyo-ku (JP)

Correspondence Address: COUDERT BROTHERS, 4 Embarcadero Center, Suite 3300, San Francisco, CA, 94111, US

(21) Appl. No.: 09/779,125

(22) Filed: Feb. 7, 2001

(30) Foreign Application Priority Data
Mar. 2, 2000 (JP) 2000-056919

(51) Int. Cl. G01N 21/74

(52) U.S. Cl. 356/312; 356/12

(57) ABSTRACT

A furnace-type atomic absorption spectrophotometer heats a sample by controlling a heating current passed to the tube inside which the sample is held. The temperature of the tube is monitored and the heating current is controlled, say, by a phase control method, such that the monitored temperature will approach a specified target temperature. The spectrophotometer includes a control unit which determines a quantity of a specified operation for the heating control such as a firing angle by a PID control calculation on the difference between the monitored temperature and a target temperature value. PID parameters are determined such that the minimum detectable quantity can be reduced.

### BACKGROUND OF THE INVENTION

This invention relates to a furnace-type atomic absorption spectrophotometer adapted to atomize a sample inside a heating tube. In particular, the invention relates to the control of such a heating tube.

A furnace-type atomic absorption spectrophotometer is adapted to have a sample placed inside a heating tube (such as a graphite tube) to atomize the sample by heating the tube to increase the temperature of the sample and to pass a beam of light therethrough to measure its absorbance. This measurement process may be described roughly as including the following three steps which are the drying step, the ashing step and the atomization step, and the temperature variation of the graphite tube in each of these steps is usually controlled by a temperature program from outside, that is, by the user.

FIG. 5 shows an example of a general temperature program set for a prior art atomic absorption spectrophotometer. FIG. 6 is a graph for showing the temperature variation according to the temperature program thus set. The example of the temperature program shown in FIG. 5 may be characterized as dividing the time into a plurality (six in the example shown) of stages and setting for each of these stages the final temperature to be reached, the time which will elapse until this final temperature is reached and the heating mode related to the temperature change. In the column for the heating mode in FIG. 5, “rump” means a mode in which the temperature is to increase uniformly, or linearly at a constant rate with respect to time and “step” means a mode in which the temperature increases suddenly in a stepwise fashion.

According to this example, as shown in FIG. 6, the water component of the sample is evaporated in the first drying step (consisting of two stages) by heating the tube for 30 seconds at temperatures below about 250° C. In the subsequent ashing step (consisting also of two stages), the tube is heated for about 20 seconds within a temperature range between 250 and 1000° C. such that organic matters contained in the sample are gasified. The temperature is usually increased gradually during the drying and ashing steps. 5 After water components and organic matters are thus removed sufficiently, the tube is rapidly heated to a high temperature (about 2000-3000° C.) in the atomization step in order to atomize the target elements which are mainly metallic components for absorption spectrophotometry.

Known examples of method for controlling temperature in each of these steps include that of using a photo-sensor of a non-contacting type to detect the intensity of infrared light from the heat-emitting graphite tube and controlling the intensity of the electric heating current passed to the tube such that the detected temperature approaches the target temperature (the optical temperature control method) and that of controlling the intensity of the heating current such that the current which flows to the graphite tube will approach a current value corresponding to the target temperature (the current control method). Of these, the optical temperature control method is advantageous in that the error in the final temperature is small although the resistance of the tube varies because the temperature of the tube is directly measured by an optical sensor and that the rise in temperature is quick and hence its response characteristic is good. In a low-temperature region where there is hardly any infrared emission, on the other hand, the temperature control is difficult by this method. For this reason, it has been known with prior art atomic absorption spectrophotometer to use the current control method in the drying step and the optical temperature control method in the ashing and atomization steps.

Since an atomic absorption spectrophotometer is frequently used for the purpose of analyzing very small quantities of samples, the minimum detectable quantity is an important indicator for its capability. It has been known that this minimum detectable quantity is proportional to the ratio (fluctuation in absorbance)/(magnitude of absorbance), where the fluctuation in absorbance means the fluctuations in the measured values obtained by making measurements on a same sample under same conditions, or the standard deviation of the measured values obtained by carrying out many measurements.

In many situations, absorbance increases if the speed of rise in temperature is increased in the atomization step. For this reason, the temperature program is usually set such that the temperature will increase as rapidly as possible in the atomization step in order to reduce the minimum detectable quantity. As shown in the example of FIGS. 5 and 6, “step” is selected as the heating mode at the end of the ashing step and at the beginning of the atomization step, and the heating current is controlled so as to increase the temperature as quickly as possible within its capability.

As explained above, however, the minimum detectable quantity depends not only on the absorbance but also its fluctuation. In general, if the temperature is increased too rapidly, it tends to overshoot and then come down to the target temperature and this causes the fluctuation to increase. In other words, it is not only the absorbance itself but also its fluctuation that increases if the speed of rise in the temperature is increased. As a result, the minimum detectable quantity may not become smaller but larger.

### SUMMARY OF THE INVENTION

It is therefore an object of this invention in view of the above to provide a furnace-type atomic absorption spectrophotometer capable of reducing the minimum detectable quantity by taking into consideration not only the magnitude of absorbance but also its fluctuation.

As explained above, prior art spectrophotometers were designed to increase the temperature as rapidly as possible so as to shorten the time required to reach the target temperature without regard to the response characteristic such as the indicial response characteristic corresponding to the step response characteristic as the temperature is increased in a stepwise fashion. A furnace-type atomic absorption spectrophotometer according to this invention, by contrast, is characterized wherein its temperature response characteristic is made variable as the increase in the temperature of the heating tube is controlled. As a result, the rise in the temperature can be controlled according to this invention by providing an optimum response characteristic, depending on the kind of the target element to be detected as well as other conditions of the measurement, such that the minimum detectable quantity can be made as small as possible. The response characteristic according to this invention is determined in units of milliseconds, unlike the prior art “rump” mode of temperature control which takes place in units of seconds.

A furnace-type atomic absorption spectrophotometer embodying this invention, with which the above and other objects can be accomplished, may be characterized as comprising a tube for heating a sample therein, monitoring means for monitoring temperature of the tube or a value indicative thereof and outputting a monitored temperature or the value indicative thereof, heating control means for controlling an electrical heating current for heating the tube such that the monitored temperature or the value indicative thereof will approach a specified target temperature value, and parameter setting means for setting parameters which determine a response characteristic of the heating control means when the tube is heated by the heating control means. The monitoring means may be an optical detector for detecting the light emitted from the tube and in such a case the value indicative of the temperature may be the intensity of the emitted light. The heating control means serves to keep updating the target temperature value or another variable value indicative of the target temperature by a predetermined temperature program and controls the heating current to the tube such that the monitored value obtained by the monitoring means will become or approach this target temperature or the value indicative thereof. Generally speaking, the heating current is increased if the difference between the target temperature and the monitored temperature is large and it is decreased if the difference is small. The response characteristic associated with this control is variable according to the parameters which are set by the parameter setting means. In typical examples, these parameters are appropriately adjusted according to the kind of target element being analyzed. The magnitude of absorbance depends differently on the speed at which temperature is raised, depending on the type of the element, In the case of an element of which absorbance depends only weakly on the rate of temperature increase, parameters are selected such that the obtained response characteristic will be such that the speed in the temperature change will not become too large because the absorbance of such an element will become saturated or its increase will be extremely small when the rate of temperature increase is made greater than a certain level. If various modifiers have been added to the sample, the parameters should be changed appropriately by taking into consideration the characteristics of these added agents.

If a current sensor for measuring the current for heating the tube is used as the monitoring means at a lower-temperature region and an optical sensor at a higher-temperature region, the selection of the parameters may be effected by taking into consideration that overshooting of the temperature over the target value tends to occur immediately after the monitoring means is switched over. Even where the same monitoring means is used, a similar tendency may be expected when the gain for amplifying the output from the monitoring means is changed and the selection of the control parameters should be effected by taking this into consideration.

In the step for atomization, strong light is emitted from the graphite tube but this takes place according to the law of black-body radiation. In other words, the intensity of the emitted light is stronger in the range of ultraviolet and visible light for light with longer wavelength. If such emitted light reaches the detector, it is likely to cause errors in the measurement. In order to eliminate effects of such emitted light, the light source may be switched on and off at intervals and the difference may be calculated between the measurements taken when the light source is switched on and off. If the change in the emission of light from the tube is too sudden within such intervals, the effects of such change in the light intensity may adversely affect the accuracy of the measurement, increasing the fluctuation in the measured absorbance. In such a case, therefore, the control parameters should be selected so as to obtain a response characteristic such that the occurrence of overshooting which causes extremely sudden changes in the light intensity will be prevented when the sample period is relatively long.

The heating control means according to this invention may be adapted to carry out a PID control calculation on the difference between the monitored and target values to obtain a quantity of specified operation. Since the quantity of the specified operation is determined by this control method from the proportional (P), integration (I) and differential operations based on the difference between the monitored and target values, proportional, integration and differential elements serve as the aforementioned control parameters. If the electric current for the heating is switched on and off by a phase control method, the firing angle for the phase control may be the aforementioned quantity of a specified operation.

### BRIEF DESCRIPTION OF THE DRAWINGS

The accompanying drawings, which are incorporated in and form a part of this specification, illustrate an embodiment of the invention and, together with the description, serve to explain the principles of the invention. In the drawings:

FIG. 1 is a schematic block diagram showing the overall structure of a furnace-type atomic absorption spectrophotometer embodying this invention;

FIG. 2 is a block diagram of the control system for the furnace-type atomic absorption spectrophotometer of FIG. 1;

FIGS. 3A, 3B, 3C and 3D, together referred to as FIG. 3, are waveform diagrams for explaining the control of power supply for heating;

FIG. 4 is a graph for showing examples of indicial response at the time of raising temperature by PID control;

FIG. 5 is an example of prior art temperature program for operating an atomic absorption spectrophotometer; and

FIG. 6 is a graph showing the temperature change corresponding to the program shown in FIG. 5.

### DETAILED DESCRIPTION OF THE INVENTION

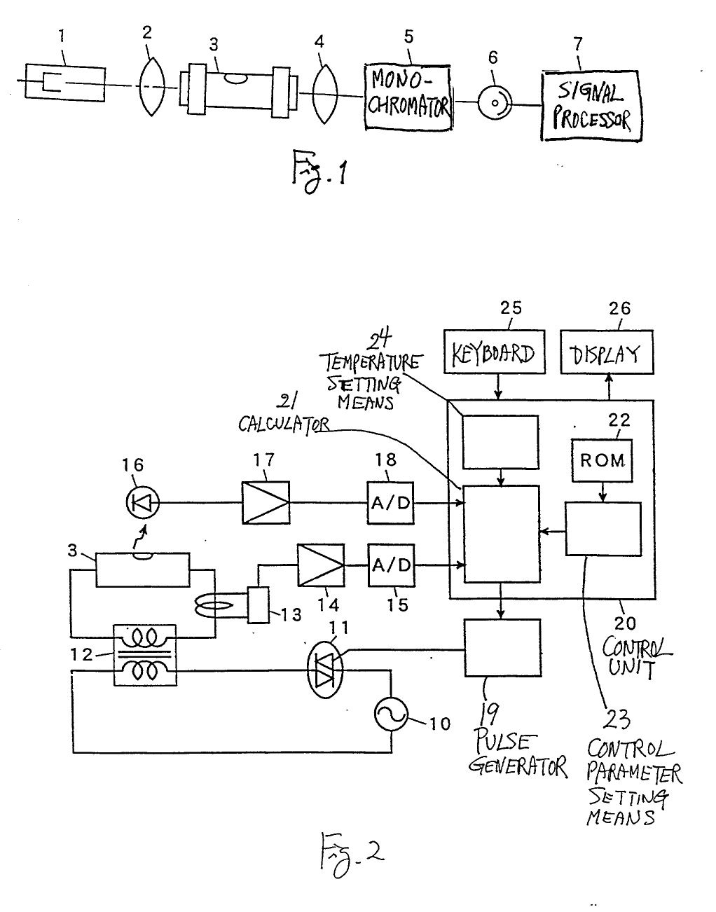

The invention is described next by way of an example with reference to the figures. FIG. 1 shows a furnace-type atomic absorption spectrophotometer embodying this invention, including a light source 1 which may comprise a hollow-cathode lamp for emitting bright-line spectral light including a resonance line of a target element to be analyzed. This spectral light from the source 1 is introduced through an optical system 2 on the upstream side into a graphite tube 3 serving as a heating tube and becomes absorbed by the atomized sample as it passes therethrough. The portions of the light having wavelengths which are characteristic of the elements contained in the sample are absorbed particularly strongly. The remaining portions of the light which passed through the graphite tube 3 is introduced through another optical system 4 on the downstream side to a monochromator 5 which serves to allow only that portion of the light with wavelength corresponding to the target element to be analyzed to pass therethrough into a detector 6. The ratio between the light intensity without the absorption by the target element and that with the absorption is calculated by a signal processor 7 and the target element is quantitatively analyzed from the absorbance thus calculated.

An electric heating current is supplied to the graphite tube 3 for heating the sample therein through the drying, ashing and atomization steps. FIG. 2 shows the structure of a control unit for controlling the heating of the graphite tube 3

As shown in FIG. 2, an AC power source 10 is connected to the primary coil of a transformer 12 through a gate-controlling semiconductor switch 11 (hereinafter referred to simply as the semiconductor switch). The secondary coil of the transformer is connected to the graphite tube 3 with a current sensor 13 provided in between for monitoring the current intensity. An optical sensor 16 is positioned near the graphite tube 3 for monitoring the intensity of infrared light emitted therefrom as it is heated, and the output from this optical sensor 16 is inputted to a calculator 21 through an amplifier 17 and an A/D convertor 18. The output from the current sensor 13 is also inputted to the calculator 21 through an amplifier 14 and an A/D convertor 15.

In addition to the aforementioned calculator 21, there are a ROM 22, a control parameter setting means 23 and a temperature setting means 24 included in a control unit 20 which may be comprised of a computer including a CPU. A keyboard 25 serving as an input means and a display device 26 serving as an output means are connected to the control unit 20. The calculator 21 serves to obtain a quantity of an operation by carrying out a PID control calculation according to a specified algorithm, this being done by having the computer to carry out a specified control program.

According to the example which is being described, the power supplied to the graphite tube 3 is controlled by a so-called phase control method. Thus, the quantity of the specified operation in this example is the firing angle related to the on-off control of the semiconductor switch 11. A pulse signal is generated by a pulse generator 19 corresponding to a firing angle calculated and given by the control unit 20 and is inputted to the control terminal of the semiconductor switch 11.

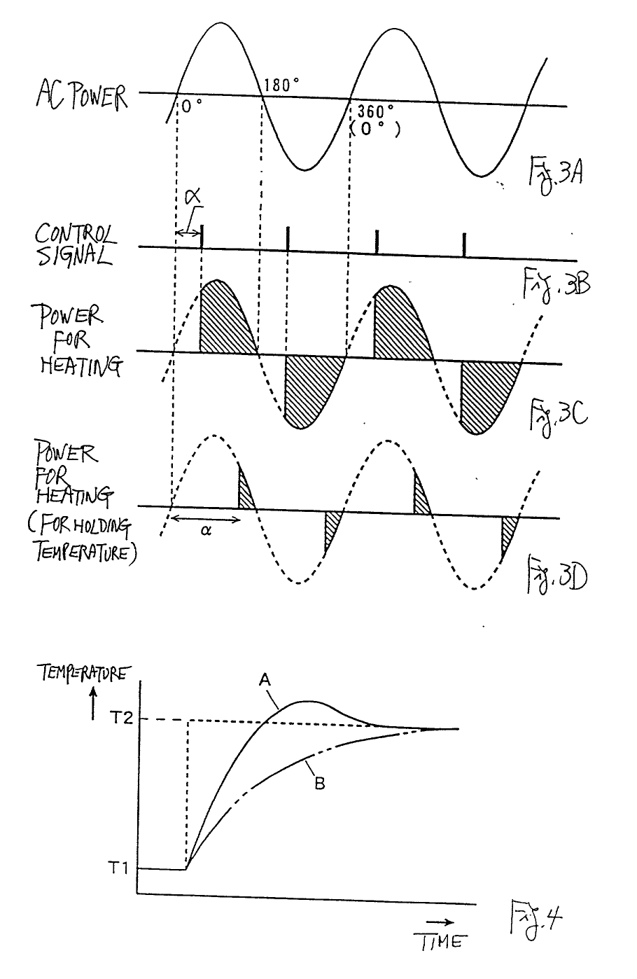

The control of power from the AC power source will be explained next with reference to the waveform diagrams of FIG. 3. FIG. 3A shows the sinusoidal waveform of the power supplied from the AC power source 10. As a pulse signal is received at points in time when the phase has advanced by the firing angle α after it becomes 0° and 180° as shown in FIG. 3B, the semiconductor switch 11 becomes conductive and remains conductive until the phase becomes respectively 180° and 360°, as shown in FIG. 3C. Explained schematically, the shaded portions in FIG. 3C contribute to the heating. Thus, the power for the heating increases as the firing angle α is reduced and the heating power decreases as the firing angle α is increased, (as shown in FIG. 3D).

Next, the operations for the temperature control of the graphite tube 3 are explained. At the beginning of a measurement, the user inputs through the keyboard 25 a temperature program such as shown in FIG. 5. The inputted temperature program is then stored in the temperature setting means 24 which already stores a target value for the optical sensor 16 corresponding to the temperature. As the graphite tube 3 is heated, the output from the optical sensor 16 corresponding to the measured temperature is inputted as a digital signal into the calculator 21 by going through the A/D convertor 18. At the same time, a target value for the optical sensor 16 corresponding to the set temperature at the present time is provided from the temperature setting means 24 to the calculator 21. The calculator 21 operates to calculate the difference between the current output value from the optical sensor 16 and the target value and calculates the firing angle α by using a calculation algorithm for the PID control on the basis of this difference value. The pulse generator 19 thereupon produces a pulse signal corresponding to this firing angle α and carries out the on/off control of the semiconductor switch 11,

For carrying out the aforementioned PID control, it is necessary to provide so-called PID control parameters including the proportional parameter P, integration parameter I and differential parameter D. If these parameters are changed, the temperature response characteristic will change at the time of rise in the temperature. Let us consider an example of control wherein the outputs from the optical sensor 16 are monitored at a sampling period of Tₛ and the outputted values are controlled so as to become stabilized at α value corresponding to the target temperature by appropriately adjusting the firing angle α which determines the power for the heating the tube 3 according to these monitored values. Let Eₖ be the error obtained by subtracting the monitored value from the target value at the time of the kth sampling (k being a dummy index). Then, the firing angle αₖ is given by the following formula:

$${α}_{k} = {K}_{p} \{ {E}_{k} + ( {T}_{s} / {T}_{i} ) {\sum }_{j = 0}^{k} {E}_{j} + ( {T}_{d} / {T}_{s} ) ( {E}_{k} - {E}_{k - 1} ) \}$$

where Kₚ, T₁ and T_{d} are PID control parameters to be set, being respectively referred to as the proportional gain, the integration time and the differentiation time.

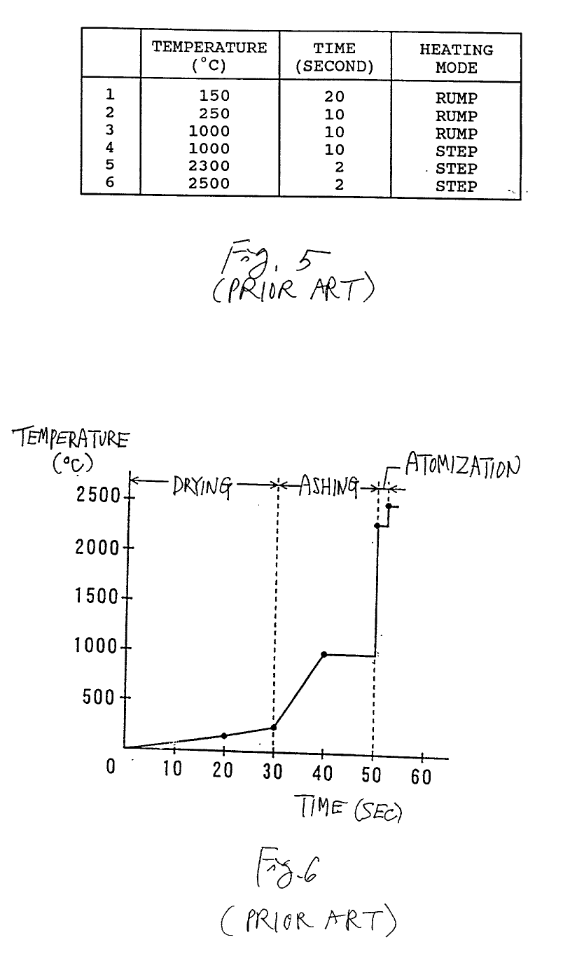

FIG. 4 shows examples of the indicial characteristic at the time of raising the temperature. Suppose that it is desired to raise the temperature from T₁ to T₂ suddenly (that is, in the “step” mode). It would be ideal if the temperature changed as indicated by dotted lines in FIG. 4 but it is impossible in practice to raise the temperature in such an abrupt manner. In a real situation, the temperature change will be as indicated by line A or B. Curve A shows a situation where the temperature is raised relatively fast such that there is an overshoot. Curve B corresponds to a situation where there is no overshooting but the temperature rise is so slow that it takes a longer time to reach the target temperature. The response characteristic of a PID control can be changed in various ways, as shown in FIG. 4, by varying these control parameters.

As explained above, the minimum detectable quantity in absorption spectroscopy is proportional to the ratio (fluctuation in absorbance)/(magnitude of absorbance), and the response characteristic for providing a smallest minimum detectable quantity changes, depending on various conditions of the measurement. The atomic absorption spectrophotometer according to the present example of the invention is characterized not only as having stored in the ROM 22 such PID control parameters that will provide an optimum response characteristic (that is, a smallest minimum detectable quantity) under standard conditions of measurement but also as allowing the user to input PID parameters for each stage or make changes on the aforementioned preset standard PID control parameters by operating on the keyboard 25 when a temperature program is set prior to the measurement. When PID control parameters are thus inputted through the keyboard 25, the control parameter setting means 23 transmits the inputted control parameters to the calculator 21 during the course of raising the temperature. If there was no input of control parameters through the keyboard 25, the control parameter setting means 23 serves to transmit to the calculator 21 the standard control parameters retrieved from the ROM 22. In other words, if the standard control parameters from the ROM 22 are transmitted to the calculator 21, the known standard response characteristic is obtained by the PID control but if different control parameters inputted through the keyboard 25 are transmitted to the calculator 21, a different response characteristic will be obtained accordingly. In summary, the user can freely input an appropriate set of control parameters, depending on the kind of target element to be analyzed and conditions of measurement, thereby adjusting the indicial response of the PID control such that the minimum detectable quantity will be made as small as possible or approach the smallest value.

The response characteristic of a PID control can be determined, for example, as follows. If the absorption wavelength of the target element is relatively short or if the intensity of the emitted light from the light source 1 is large, the effect of light emitted from the graphite tube 3 and introduced into the detector 6 is relatively small. Thus, even if the temperature overshoots the target level and the light from the graphite tube 3 changes suddenly, this does not cause a large fluctuation in absorbance. In such a case, the minimum detectable quantity can be reduced by selecting a response characteristic which will cause the temperature to rise rapidly. If the absorption wavelength of the target element is relatively long or if the intensity of the emitted light from the light source 1 is small, the minimum detectable quantity can be reduced by selecting a response characteristic which will make the speed of rise in the temperature relatively small. If various modifiers are added to the sample, the PID control parameters should be selected by taking into consideration the characteristics of such added agents in order to reduce the minimum detectable quantity.

If the spectrophotometer is adapted to carry out a signal processing whereby the light source is switched on and off and the result of measurement when the light is switched off is subtracted from the result of measurement when the light is switched on in order to eliminate the effects of light from the graphite tube 3 on the detector 6, the response characteristic should be made relatively slower if the time intervals for the measurements while the light is switched on and off are relatively long. It is because this has the effect of controlling the overshooting and the light from the graphite tube 3 does not change suddenly within the time intervals while the light is switched on and off. As a result, the fluctuation in absorbance can be reduced and the minimum detectable quantity can be made smaller.

According to one example embodying this invention, the heating current is controlled according to the output from the current sensor 13 within a specified temperature range such as below 600° C. Explained more in detail, the temperature setting means 24 also stores target values for the current sensor 13 individually corresponding to each of set temperature within the aforementioned specified temperature range. The output from the current sensor 13 at the time of heating is converted into a digital signal by the A/D convertor 15 and inputted to the calculator 21 while the temperature setting means 24 transmits to the calculator 21 the target value for the current sensor 13 corresponding to the set temperature at the present time. The calculator 21 then calculates the difference between the outputted value from the current sensor 13 at the present moment and the target value and obtains the firing angle α by using a specified algorithm on the basis of this difference. Such control of a heating by the current control method is done as has conventionally been done.

When the temperature rises to a specified level, the aforementioned optical temperature control method using the output from the optical sensor 16 is used. Sometimes, the overshooting is likely to occur immediately after the method is changed. Thus, the response characteristic should then be changed to a slower one immediately after a switch in the control method.

It is known in the PID control that the response characteristic tends to become slower if the parallel or differential parameter is made smaller. If it is made too small, however, it is not practical because it takes too long to reach the target temperature. Thus, it is preferable to design the control unit 20 such that the PID control parameters can be changed only within a specified range. It is also preferable to arrange the control unit 20 such that a selected minimum firing angle α can be inputted through the keyboard 25 or be stored in the ROM 22 such that no firing angle α smaller than this minimum value will be used in the control. Thus, the response characteristic can be made slower without causing the time to reach the target temperature to become too long and reducing the possibility of occurrence of overshooting.

Although the invention has been described above with reference to only one example but this example is not intended to limit the scope of the invention. Many modifications and variations are possible within the scope of the invention. For example, although it was shown that the PID control parameters are to be inputted by the user, control parameters which will minimize the minimum detectable quantity under several different conditions of measurement may be preliminarily stored such that the user has only to input conditions of measurement from the keyboard 25 such that appropriate control parameters are automatically selected and inputted to the calculator 21.

The control unit 20 may be also so designed that PID control parameters will be automatically set so as to minimize the minimum detectable quantity or make it approach such a minimum value under a given condition. Explained more in detail, this may be done when a measurement is to be made on a certain sample under a certain condition by repeating measurements with a set of PID control parameters while varying them and thereby obtaining an average absorbance value and its standard variation and finding PID control parameters that will minimize their ratio. Such PID control parameters thus determined for different conditions of measurement may be stored in a memory such that, when a condition is specified, PID control parameters corresponding to the specified condition can be retrieved from the memory.

What is claimed is:

1. A furnace-type atomic absorption spectrophotometer comprising:
a tube for heating a sample therein;
monitoring means for monitoring temperature of said tube and outputting a monitored value indicative of the monitored temperature;
heating control means for controlling heating current for heating said tube such that said monitored value will approach a specified target temperature value; and
parameter setting means for setting parameters which determine a response characteristic of said heating control means when said tube is heated by said heating control means.

2. The spectrophotometer of claim 1 wherein said heating control means includes a calculator for obtaining a quantity of a specified operation of said heating control means by a PID control calculation on difference between said monitored value and said target temperature value and said parameter setting means serves to set at least one of parameters for said PID control calculation.

3. The spectrophotometer of claim 1 wherein said parameter setting means includes an input device for allowing a user to input therethrough said parameters.

4. The spectrophotometer of claim 1 wherein said parameter setting means include an input device for allowing a user to input therethrough a condition corresponding to said parameters.

5. The spectrophotometer of claim 2 wherein said parameter setting means include an input device for allowing a user to input therethrough said parameters.

6. The spectrophotometer of claim 2 wherein said parameter setting means include an input device for allowing a user to input therethrough a condition corresponding to said parameters.

7. The spectrophotometer of claim 2 wherein said PID control is carried out with a parallel parameter, an integration parameter and a differential parameter.

8. The spectrophotometer of claim 1 wherein said monitoring means monitors values indicative of the temperature of said tube.

9. The spectrophotometer of claim 1 wherein said parameter setting means includes a memory which stores sets of parameters corresponding to different measurement conditions.

10. The spectrophotometer of claim 3 wherein said parameter setting means includes a memory which stores sets of parameters corresponding to different measurement conditions and said input device allows a condition to be inputted therethrough, said parameter setting means selecting one of said sets of parameters according to said condition inputted through said input device.

11. The spectrophotometer of claim 2 wherein said heating control means controls said heating current by a phase control method and said quantity of a specified operation is a firing angle.
